(19) United States
(12) Patent Application Publication
(10) Pub. No.: US 2011/0192199 A1
(43) Pub. Date: Aug. 11, 2011

(54) SKIVING BELL

(75) Inventors: Bernd MERLE, Alsfeld (DE); Achim SPYCHALSKI-MERLE, Alsfeld (DE)

(73) Assignee: PF SCHWEISSTECHNOLOGIE GMBH, Alsfeld (DE)

(21) Appl. No.: 13/021,368

(22) Filed: Feb. 4, 2011

(30) Foreign Application Priority Data
Feb. 5, 2010 (DE) 102010006990.6-14

(51) Int. Cl. C14B 1/14

(52) U.S. Cl. 69/9

(57) ABSTRACT

The present invention relates to a skiving apparatus for at least partial removal of the outer circumferential surface of rotationally symmetric objects, in particular cylindrical plastic pipes, said apparatus containing a bell-shaped housing with a central longitudinal axis, said housing having a skiving recess which is coaxially aligned with the central longitudinal axis—and outwardly open at one end face of the bell-shaped housing via a feed opening. Disposed in said housing is a blade which projects into the skiving recess with its cutting edge aligned preferably parallel to the central longitudinal axis of said housing. According to the invention, the blade is mounted in a blade guide such that the blade is reversibly displaceable in the direction of the central longitudinal axis of the housing.

### CROSS REFERENCE TO RELATED APPLICATIONS

This application claims benefit of pending German Application No. 10 2010 006 990.6-14 filed on Feb. 5, 2010.

### BACKGROUND OF THE INVENTION

The present invention relates to a skiving apparatus for at least partial removal of the outer circumferential surface of rotationally symmetric objects, in particular cylindrical plastic pipes, in accordance with the preamble of claim 1.

More specifically, the present invention relates to a skiving apparatus for at least partial removal of the outer circumferential surface of rotationally symmetric objects, in particular cylindrical plastic pipes, said apparatus containing a bell-shaped housing with a central longitudinal axis, said housing having a skiving recess which is coaxially aligned with the central longitudinal axis and outwardly open at one end face of the bell-shaped housing via a feed opening, and disposed in said housing a blade which projects into the skiving recess with its cutting edge aligned preferably parallel to the central longitudinal axis of said housing.

Special treatment of rotationally symmetric objects, for example cylindrical plastic pipes, which are to be joined at their ends to each other or to other molded parts such as T-pieces or crosspieces, for example by electrofusion fittings and electrofusion welding, in order to obtain a reliable and/or fluid-tight connection, is known in practice. Fluid media, such as water or gases, can be transported in such plastic pipes. In order to produce a transportation network of this kind, a large number of plastic pipes are joined to each other by welding or bonding, for example via pipe collars or with pipe fittings.

Plastic pipes of the kind used for the aforementioned purposes have a predefined nominal diameter. However, the diameter of these pipes always has a tolerance, which means that the real diameter of the pipes is greater than the nominal diameter. Such pipes may also have scratches or the like on their outer circumferential surfaces near their ends, or a shape that deviates from the cylindrical outer contour. To prepare the joint, the ends of such plastic pipes are therefore brought to the nominal diameter by means of a skiving apparatus, with the top layer of the pipe being removed along a specific length at the end to be joined. In the process, the diameter of the pipe is corrected and any surface damage such as scratches or the like are removed.

A skiving apparatus of the kind initially specified is known from German utility model DE 296 12 668 A1. This skiving apparatus has a cylindrical skiving member with a round, central opening that is aligned with the longitudinal axis of the skiving member. A knife opening is provided in the side wall of the skiving member. The skiving knife is inserted into the knife opening and fastened by means of a screw fastener or similar. Longitudinal ribs on the outside of the skiving member allow ease of handling.

The rotationally symmetric objects to be treated, especially the cylindrical plastic pipes and their ends, do not always have a perfectly circular cross-section, however. In many cases, the pipe ends exhibit ovalities caused during transportation or production. If these ends are treated with prior art skiving apparatus, swarf of varying thickness is removed from their surface. This can lead to the treated pipe end having a diameter that deviates from the nominal diameter, i.e., which is too small or too large. When unevenly thick swarf is removed, this also results in varying thickness of the pipe wall, which can lead to impermissibly thin pipe walls in the region of the bulge if there is any ovality in the pipe. In such cases, it not possible to join this pipe end optimally to a pipe fitting, for example. Leaky joints may then result. It is then necessary to skive the shortened pipe again, or to repair the leaky welding or bonding seam, which involves additional cost and effort.

### BRIEF SUMMARY OF INVENTION

It is therefore an aspect of the present invention to provide a skiving apparatus which overcomes the aforementioned disadvantages and permits effective as well as reliable joints between the pipe ends and the respective pipe fittings.

The aforesaid aspect is achieved by the features of claim 1. Advantageous configurations of the invention are described in the subsequent claims 2-14.

More specifically, the object specified above is achieved by a skiving apparatus for at least partial removal of the outer circumferential surface of rotationally symmetric objects, in particular cylindrical plastic pipes, said apparatus containing a bell-shaped housing with a central longitudinal axis, said housing having a skiving recess which is coaxially aligned with the central longitudinal axis and outwardly open at one end face of the bell-shaped housing via a feed opening. A blade is disposed in the housing in such a way that its cutting edge, which is aligned preferably parallel to the central longitudinal axis of the bell-shaped housing, projects into the skiving recess. According to the invention, the blade is also mounted in a blade guide such that it is reversibly displaceable in the direction of the central longitudinal axis of the housing. Due to the displaceability of the blade, it is possible to adapt to ovalities and unevenness of the pipe, as a result of which its outer contour can be travelled along very precisely and uniformly thick swarf removed from the end of the pipe.

In one preferred embodiment of the skiving apparatus according to the invention, the blade is reversibly displaceable in the blade guide in the direction of the central longitudinal axis of the housing against the force of a spring, which results in automatic adjustment of the blade penetration depth.

An opening is provided in the housing of the skiving apparatus for ejecting the skived swarf. This opening may coincide with the opening for the blade and/or the blade guide.

The blade guide may be integrally joined to the housing. In this embodiment, the blade guide may be integrated into the housing during the production process for the housing.

However, the blade guide may also be embodied as a separate component, in which case the blade guide is mounted in the opening of the housing.

To prevent the blade from projecting too far out of the housing or being lost, a support bracket may be provided to secure the blade in the blade guide.

In another preferred embodiment, the blade may be joined to the support bracket. In this embodiment, it is possible to produce the blade and the support bracket from the same material and in a single production process.

In another embodiment of the skiving apparatus according to the invention, the support bracket may be reversibly and displaceably mounted opposite the housing. In such a case, the blade, which is then fixedly joined to the support bracket, can be moved together with the support bracket.

In the case of a displaceably disposed support bracket, a spring element is disposed between the support bracket and the housing in order to allow reversible displacement of the blade.

According to another preferred embodiment of the skiving apparatus according to the invention, a spring element may be disposed between the support bracket and the blade. In this case, only the blade is moved, which can then be replaced as a single part separately from the support bracket.

However, spring-elastic displacement of the blade can also be achieved by the support bracket having spring-elastic properties. This saves one component, namely a separate spring, which simplifies construction of the skiving apparatus.

In one advantageous embodiment of the skiving apparatus, a depth stop is provided to limit the depth of penetration of the blade into the skiving recess, thus limiting the maximum thickness of the swarf that can be removed and hence the minimum pipe diameter that can be obtained.

In order to skive a defined length of the pipe end, a preferably adjustable depth stop is also provided in the housing of the skiving apparatus to limit the insertion depth of the object to be skived. If it is not necessary to adjust the depth stop, the insertion depth can be defined by the overall height of the skiving apparatus.

In another embodiment of the skiving apparatus according to the invention, the housing has an external contour, in the region of the end opposite the feed opening of the skiving recess, which allows the skiving apparatus to be clamped into a chuck of an external drive mechanism. This outer contour may be in the shape of a cylindrical pin, or have a polygonal cross-section. Such a pin may also be provided with a thread by means of which it can be screwed into the respective end of the skiving apparatus so that it can be removed in the case of the skiving apparatus being used manually.

### BRIEF DESCRIPTION OF THE SEVERAL VIEWS OF THE DRAWINGS

Other advantageous configurations and an embodiment of the invention shall now be described with reference to the description of an embodiment and to the attached drawings. The terms “top”, “bottom”, “left” and “right” used when describing the embodiment relate to the drawings oriented in such a way that the reference signs and names of the figures can be read normally. In the drawings,

FIG. 1: shows a perspective schematic view of an embodiment of the skiving apparatus according to the invention.

FIG. 2: shows the base member of the skiving apparatus according to the invention, in which a support bracket a knife have been dismounted; and

FIG. 3: shows the support bracket and knife of the embodiment of the skiving apparatus according to the invention.

### DETAILED DESCRIPTION OF THE INVENTION

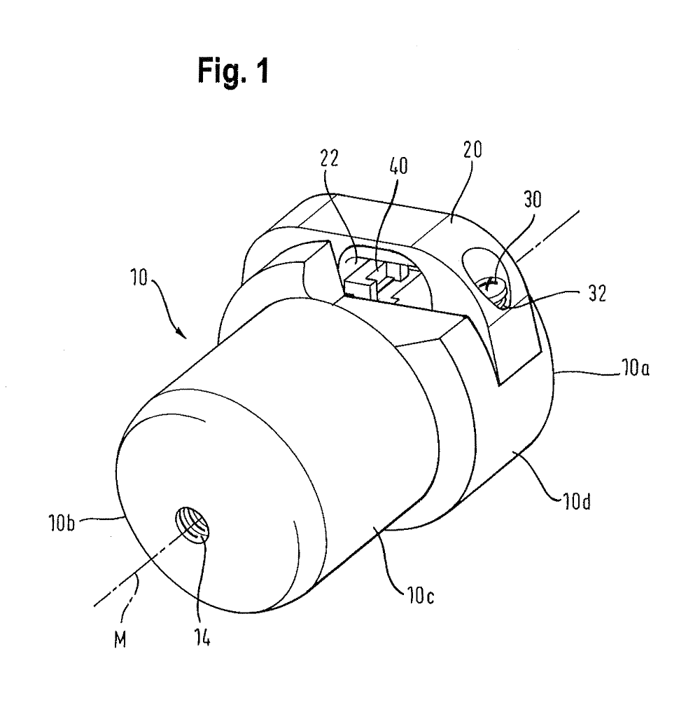

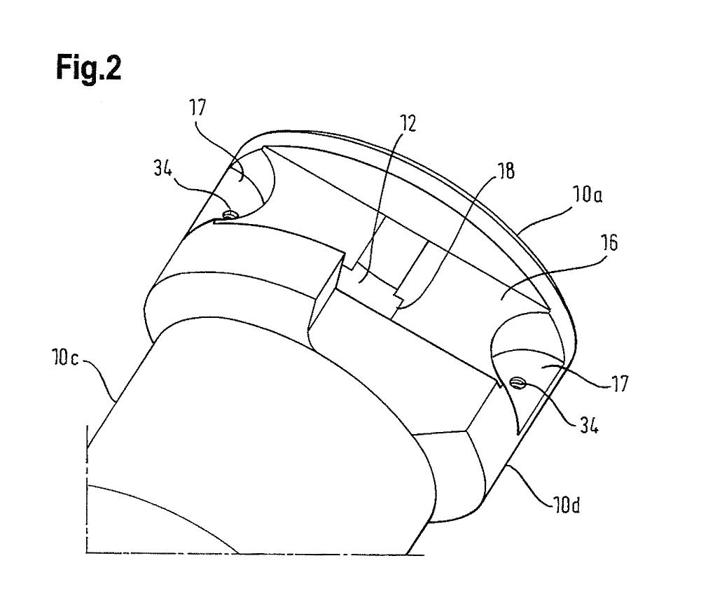

FIG. 1 shows a perspective schematic view of an embodiment of the skiving apparatus according to the invention. The skiving apparatus has an approximately rotationally symmetric housing or base member 10 with a central longitudinal axis M. Base member 10 is bell-shaped. From its right-hand side 10a in FIG. 1, there is integrated an approximately cylindrical recess called the skiving recess 12 (cf. FIG. 2) and comprising a feed or insertion opening located on the right-hand side 10a of base member 10 for insertion of the pipe end to be skived. The skiving recess 12 is aligned coaxially with the central longitudinal axis M of base member 10 and ends as a blind hole at a sufficient distance from the left-hand end 10b of housing or base member 10 as seen in FIG. 1. A through bore 14 in which an internal thread, not defined in any further detail, is provided is incorporated in the left-hand end and is likewise aligned coaxially with the central longitudinal axis M.

Base member 10 is subdivided at its outer circumference into a left-hand, completely rotationally symmetric portion 10c and a right-hand portion 10d which is likewise rotationally symmetric, but which includes a mounting recess 16 in the form of an approximately semi-circular segment into which a support bracket 20 is inserted and held by means of two screws 30, only one of which is visible in FIG. 1. Screws 30 are aligned parallel to each other and in one plane perpendicular to the central longitudinal axis M and tangentially to skiving recess 12. The outer diameter of portion 10d is greater than that of portion 10c. The inner diameter of both portions 10c, 10d are identical as far as skiving recess 12 extends.

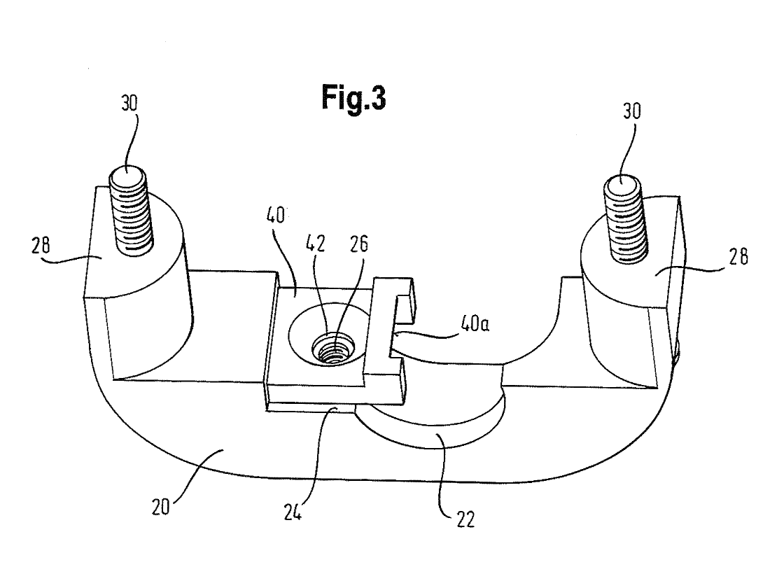

Support bracket 20, which is shown in FIG. 3, likewise has approximately the shape of a semi-circular segment. Its width equals the width of mounting recess 16, but it is slightly taller in the embodiment shown, so support bracket 20 projects above portion 10d of base member 10. Support bracket 20 is held in mounting recess 16 of base member 10 by screws 30 which engage in matching threaded holes 34 in the housing or base member 10. However, screws 30 are not fully tightened. The underside of the heads of screws 30 and the respective support surface on support bracket 20 are spaced apart from each other. A cylindrical pressure spring 32 is disposed between these surfaces around the shafts of screws 30. Spring 32 is supported at the screw head, thus pressing support bracket 20 perpendicularly to central longitudinal axis M into recess 16 of base member 10.

On its inner side, support bracket 20 has a recess 24 in which a knife 40 is disposed. Knife 40 is arranged in such a way that it projects a specific depth into skiving recess 12 with its cutting edge 40a. Cutting edge 40a of knife 40 is aligned at least approximately parallel to the central longitudinal axis M of housing 10. On the inner side of support bracket 20, a swarf recess 22 is provided to facilitate ejection of the swarf.

In skiving recess 12 a circumferential edge (not shown) is provided which projects perpendicularly to central longitudinal axis M into cylindrical skiving recess 12. This circumferential edges forms a depth stop for limiting the insertion depth of the pipe into the skiving apparatus. As an alternative, skiving recess 12 may contain a reduction of diameter in the form of stepwise gradation that fulfills the same purpose. In the most simple case, the insertion depth of the pipe is limited by the overall height of base member 10 and by the depth of skiving recess 12. The diameter of cylindrical skiving recess 12 is equal to the nominal diameter of the pipe to be processed. Since the length to be skived depends on the nominal diameter of the pipe, the position of the insertion depth stop is adapted thereto.

FIG. 2 shows base member 10 of the skiving apparatus, with support bracket 20 removed. In the middle region of mounting recess 16, a hole 18 through to skiving recess 12 can be seen, which is used as a swarf ejection opening. A recess corresponding to the swarf recess 22 of support bracket 20 and which likewise facilitates the ejection of swarf and permits visual control of knife 40 when mounted is also provided on the left-hand edge of portion 10d. At the ends of the area formed by mounting recess 16, recesses 17 extend perpendicularly thereto. Said recesses 17 are substantially cylindrical in shape and have an approximately semi-circular cross-section. Tapped holes 34 extend from the bottom of the recesses into base member 10, into which screws 30 are screwed. Due to the limited amount of material of base member 10, bores 34, which are executed as blind holes, have a predefined depth. Screws 30 have a length that is adapted thereto and also to the height of support bracket 20, so a defined length of the screw shaft is left free in order to dispose spring 32 thereon.

FIG. 3 shows support bracket 20 with knife 40, which lies in a knife rest 24 that is provided. Knife 40 is fixed by means of a screw that is not shown in FIG. 3. For this purpose, knife 40 has a central bore 42 which is aligned coaxially with a tapped hole 26 in support bracket 20 when knife 40 is positioned accordingly. Bore 42 has a countersink so that a countersunk screw with which knife 40 is fixed is flush with the surface of knife 40. Recess 22 in support bracket 20 is designed in such a way that cutting edge 40a of knife 40 remains free, i.e., does not come into contact with support bracket 20. Recess 22 is also non-symmetrical. When viewed in the mounted state as shown in FIG. 1, it widens in the direction of the left-hand end 10b of housing 10 of the skiving apparatus. In this way, swarf ejection can be steered in this direction, thus preventing the swarf from getting into the insertion opening for the pipe to be skived during the skiving operation, i.e. into skiving recess 12, and thus having an adverse effect on the skiving process.

Cylindrical extensions 28 of approximately semi-circular cross-section are located at the two lateral ends of support bracket 20. They are aligned parallel to each other and when support bracket 20 is mounted they face in a direction that is approximately perpendicular to the central longitudinal axis M. Extensions 28 are identical in cross-section and length to recesses 17, so that when support bracket 20 is mounted it abuts the surface formed by mounting recess 16. Extensions 28 are guided thereby into recesses 17. Screws 30, of which only the threaded bolts can be seen in FIG. 3, fix support bracket 20 in said guide. The springs 32 provided between the screw heads and support bracket 20 exert a defined force on support bracket 20, thus pressing the latter into mounting recess 16 and onto the surface formed by mounting recess 16. Support bracket 20 and the support surface 24 incorporated therein for knife 40 are embodied in such a way that the cutting edge of knife 40 projects a specific depth into skiving recess 12.

When preparing to join a PE pipe, for example, e.g. by welding, to a matching pipe fitting such as an electrofusion fitting, the respective end of the pipe is skived. Depending on the diameter of the pipe, the top layer of the pipe material is removed along a certain length. This layer to be removed may likewise be a metal jacket used to stabilize the pipe. The diameter of the unprocessed pipe is greater than the nominal diameter, usually with a tolerance of +0.4 mm (2×0.2 mm). The skiving apparatus is placed onto the end of the pipe and manually turned, for example. Knife 40 if guided over the end of the pipe and skives one or more pieces of swarf from the end of the pipe, which are then discharged from the skiving apparatus via the swarf recess.

The dimensions of support bracket 20 and specifically of support 24 for knife 40 are selected here such that a piece of swarf with a thickness of 0.2 mm is removed from the pipe with a single rotation of the skiving apparatus placed over the end of the pipe. The effect of limiting the insertion depth is that the end of the pipe is skived along the respective predetermined length.

Plastic pipes and especially their ends can have ovalities and flattened areas as a result of transportation or production. When used on such oval pipe ends, prior art skiving apparatus with a fixed skiving knife remove swarf to a depth that is not constant. Too little material is removed, for example from flattened areas, or too much material is removed, for example in the region of a bulge in the case of ovality. The result is either a diameter that is too great and which prevents the end of the pipe from being inserted into the matching pipe fitting, or a proper welding or bonding seam is prevented by there being too little material when the diameter is too small. If the pipe diameter is too large, there is also the risk of the excess material impermissibly reducing the inner diameter of the pipe when it is joined by welding. There is also the risk, when too much material is removed, that the walls of the pipe are impermissibly weakened at least in sections, which can lead to the walls of the pipe collapsing in that region when there is too much heat transfer.

By means of spring 32, knife 40 exerts a defined force on the pipe. In the case of a pipe end with a circular diameter, swarf of constant thickness is removed from the pipe end. If there is any ovality in the end of the pipe, knife 40 can yield in the outward direction against the force of spring 32, i.e. perpendicularly to the central longitudinal axis M, or in the case of flattening can move inwards to compensate. Knife 40 thus remains in constant contact with the pipe end and can therefore achieve uniform removal.

As an alternative to knife 40 being screwed onto support bracket 20, it can also be produced integrally with and from the same material as support bracket 20, thus reducing the number of components in the skiving apparatus.

The complexity of construction and parts can be further reduced if support bracket 20 has spring-elastic properties that allow knife 40 to move, in which case there is no need for any additional springs 32.

It is likewise conceivable that only one spring 32 be used, if this is positioned between knife 40 and support bracket 20, although a screw must be provided in this case also, so that a free portion of the threaded bolt is provided for receiving spring 32.

However, support bracket 20 may be embodied in other ways also. It is conceivable, for example, to connect one side of the support bracket rotatably to base member 10, for example by means of a articulated joint, and to provide a screw/spring combination on the other side. A torsion spring may also be provided in the rotatable connection between the support bracket 20 and base member 10.

A linear guide for knife 40, in which the knife is displaceably held, may also be provided in support bracket 20 or base member 10. A cover containing a spring element or fixing a spring element between itself and the knife secures the knife against slipping out or presses it with a specific force in the direction of the central longitudinal axis M.

Regardless of how the spring-elastic mounting of the knife is designed, the force exerted on the knife by the spring is selected by choosing a suitable spring curve. In this way, the skiving apparatus can also be adapted to pipe materials of different hardnesses.

A bolt may be screwed into the tapped hole 14 provided in the left-hand end of the skiving apparatus in FIG. 1 in order to clamp the skiving apparatus into a chuck of a drilling machine or some other drive unit to allow the skiving apparatus to be used for machining. Such a bolt or indeed any other suitable element may, of course, be integrally formed as part of housing 10 during production thereof, for example during casting, lathing or milling.

Due to the displaceably mounted knife 40 and the uniform amount of material removed as a result, the skiving apparatus does not need a centering device. This means it is possible to process pipe ends that cannot be centered, in which a mechanism such as a gas stop valve or the like is accommodated. However, centering can nevertheless be provided or easily retrofitted, for example by screwing a centering pin into tapped hole 14.

However, tapped hole 14 can also be used to receive an inside centering element containing a threaded spindle. This can be guided into a counterpart inside the pipe end. This results in a guided feed or advance corresponding to the thread pitch and the number of rotations, with which the feed rate can be controlled very well, especially in the case of machining. A depth stop would not be necessary in that case.

What is claimed is:

1. A skiving apparatus for at least partial removal of the outer circumferential surface of rotationally symmetric objects, in particular cylindrical plastic pipes, said apparatus containing a bell-shaped housing with a central longitudinal axis, said housing having a skiving recess which is coaxially aligned with the central longitudinal axis and outwardly open at one end face of the bell-shaped housing via a feed opening, and disposed in said housing a blade which projects into the skiving recess with its cutting edge aligned preferably parallel to the central longitudinal axis of said housing,
wherein the blade is mounted in a blade guide such that the blade is reversibly displaceable in the direction of the central longitudinal axis of the housing.

2. The skiving apparatus of claim 1, wherein the blade is reversibly displaceable in the blade guide in the direction of the central longitudinal axis of the housing against the force of a spring.

3. The skiving apparatus of claim 2, wherein an opening is provided in the housing for ejecting the skived swarf.

4. The skiving apparatus of claim 3, wherein the blade guide is integrally joined to the housing.

5. The skiving apparatus of claim 4, wherein the blade guide is mounted in the opening of the housing.

6. The skiving apparatus of claim 5, wherein a support bracket is provided and is adapted to secure the blade in the blade guide.

7. The skiving apparatus of claim 6, wherein the blade is connected to the support bracket.

8. The skiving apparatus of claim 7, wherein the support bracket is reversibly and displaceably mounted opposite the housing.

9. The skiving apparatus of claim 8, wherein a spring element is disposed between the support bracket and the housing.

10. The skiving apparatus of claim 9, wherein a spring element is disposed between the support bracket and the blade.

11. The skiving apparatus of claim 10, wherein the support bracket has spring-elastic properties.

12. The skiving apparatus of claim 11, wherein a depth stop is provided and is adapted to limit the penetration depth of the blade into the skiving recess (12).

13. The skiving apparatus of claim 12, wherein a depth stop is provided in the housing and is adapted to limit the insertion depth of the object to be skived.

14. The skiving apparatus of claim 13, wherein in the region of the end opposite the feed opening of the skiving recess the housing has an external contour which allows the skiving apparatus to be clamped into a chuck of an external drive mechanism.

15. The skiving apparatus of claim 1, wherein an opening is provided in the housing for ejecting the skived swarf.

16. The skiving apparatus of claim 15, wherein the blade guide is integrally joined to the housing.

17. The skiving apparatus of claim 16, wherein a support bracket adapted to secure the blade in the blade guide is provided and wherein the blade is connected to the support bracket.

18. The skiving apparatus of claim 17, wherein the support bracket has spring-elastic properties.

19. The skiving apparatus of claim 18, a depth stop is provided in the housing and is adapted to limit the insertion depth of the object to be skived.

20. The skiving apparatus of claim 17, wherein a spring element is disposed between the support bracket and the housing.
